(19) United States
(12) Patent Application Publication
(10) Pub. No.: US 2025/0094472 A1
(43) Pub. Date: Mar. 20, 2025

(54) DISPLAY DEVICE, DISPLAY METHOD, AND RECORDING MEDIUM

(71) Applicant: NEC Corporation, Tokyo (JP)

(72) Inventors: Shota KIZUKURI, Tokyo (JP); Takahisa YUTOKU, Tokyo (JP); Yoshihiko KOIZUMI, Tokyo (JP)

(73) Assignee: NEC Corporation, Tokyo (JP)

(21) Appl. No.: 18/810,704

(22) Filed: Aug. 21, 2024

(30) Foreign Application Priority Data
Sep. 19, 2023 (JP) 2023-150832

(51) Int. Cl. G06F 16/34; G06T 11/00; G10L 13/08

(52) U.S. Cl. CPC G06F 16/345; G06T 11/00; G10L 13/08

(57) ABSTRACT

A display device includes at least one memory configured to store instructions; and at least one processor configured to execute the instructions to: acquire an article regarding cybersecurity; generate a summary sentence obtained by summarizing the article using a language model; and display the summary sentence.

This application is based upon and claims the benefit of priority from Japanese Patent Application No. 2023-150832, filed on Sep. 19, 2023, the disclosure of which is incorporated herein in its entirety by reference.

### TECHNICAL FIELD

The present disclosure relates to a display device, a display method, and a recording medium.

### BACKGROUND ART

There are techniques for providing news articles regarding cybersecurity. For example, JP 2021-131715 A discloses a technology of recommending an article such as threat information regarding a cyberattack to a user.

### SUMMARY

An example of an object of the present disclosure is to provide a display device or the like capable of easily grasping contents of an article regarding cybersecurity.

A display device according to an aspect of the present disclosure includes: at least one memory configured to store instructions; and at least one processor configured to execute the instructions to: acquire an article regarding cybersecurity; generate a summary sentence obtained by summarizing the article using a language model; and display the summary sentence.

A display method according to one aspect of the present disclosure causes a computer to execute: acquiring an article regarding cybersecurity; generating a summary sentence obtained by summarizing an article using a language model; and displaying a summary sentence.

A program according to an aspect of the present disclosure causes a computer to execute: acquiring an article regarding cybersecurity, generating a summary sentence obtained by summarizing an article using a language model; and displaying a summary sentence.

The program may be stored in a non-transitory computer-readable recording medium.

### BRIEF DESCRIPTION OF THE DRAWINGS

Exemplary features and advantages of the present disclosure will become apparent from the following detailed description when taken with the accompanying drawings in which:

FIG. 1 is a functional block diagram illustrating an example of a configuration of a display device in the present disclosure;

FIG. 2 is a diagram illustrating a hardware configuration in which the display device in the present disclosure is implemented by a computer device and its peripheral devices;

FIG. 3 is an example of a display screen for displaying a summary sentence of an article in the present disclosure;

FIG. 4 is a flowchart illustrating an operation of the display device in the present disclosure;

FIG. 5 is a functional block diagram illustrating an example of a configuration of the display device in the present disclosure;

FIG. 6 is an example of a display screen for displaying a summary sentence of an article in the present disclosure;

FIG. 7 is a flowchart illustrating an operation of the display device in the present disclosure;

FIG. 8 is a functional block diagram illustrating an example of a configuration of the display device in the present disclosure;

FIG. 9 is an example of a display screen for displaying a summary sentence of an article in the present disclosure;

FIG. 10 is a flowchart illustrating an operation of the display device in the present disclosure; and

FIG. 11 is an example of a display screen for displaying a summary sentence of an article in the present disclosure.

### EXAMPLE EMBODIMENT

Hereinafter, example embodiments of a display device, a display method, a program, and a non-transitory recording medium recording the program according to the present disclosure will be described in detail with reference to the drawings. The present example embodiment does not limit the disclosed technology.

### First Example Embodiment

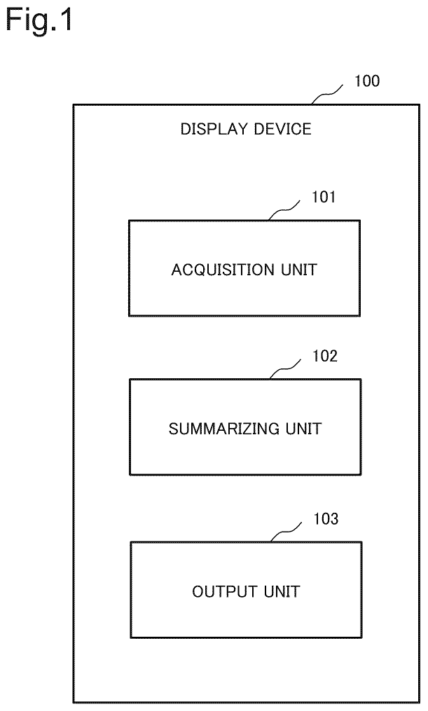

FIG. 1 is a functional block diagram illustrating an example of a configuration of a display device 100 in the present disclosure. The display device 100 is a device for displaying a summary sentence of an article regarding cybersecurity. Referring to FIG. 1, the display device 100 includes an acquisition unit 101, a summarizing unit 102, and an output unit 103.

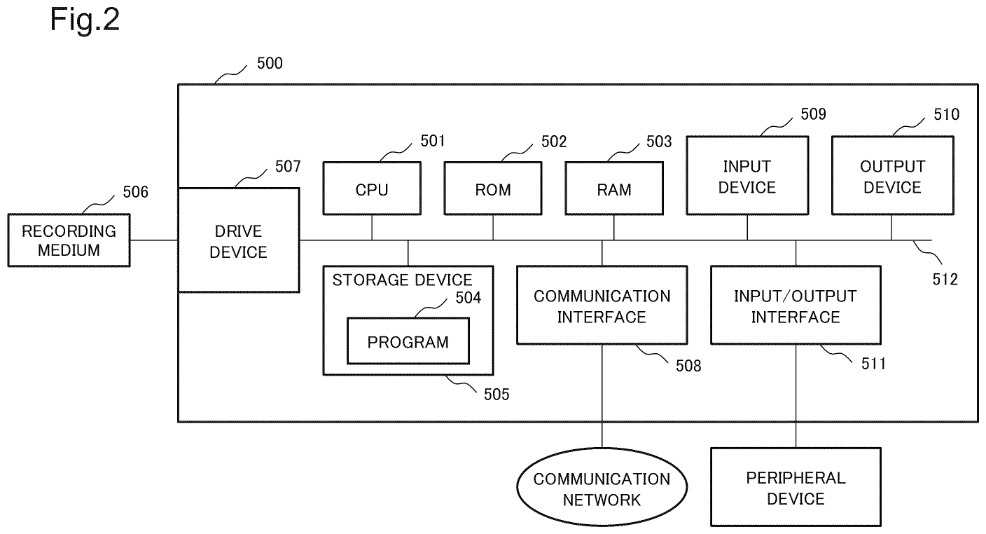

FIG. 2 is a diagram illustrating an example of a hardware configuration in which the display device 100 in the present disclosure is achieved by a computer device 500 including a processor. As illustrated in FIG. 2, the display device 100 includes a central processing unit (CPU) 501, a memory such as a read only memory (ROM) 502 and a random access memory (RAM) 503, a storage device 505 such as a hard disk that stores a program 504, a communication interface 508 for network connection, and an input/output interface 511 that inputs and outputs data.

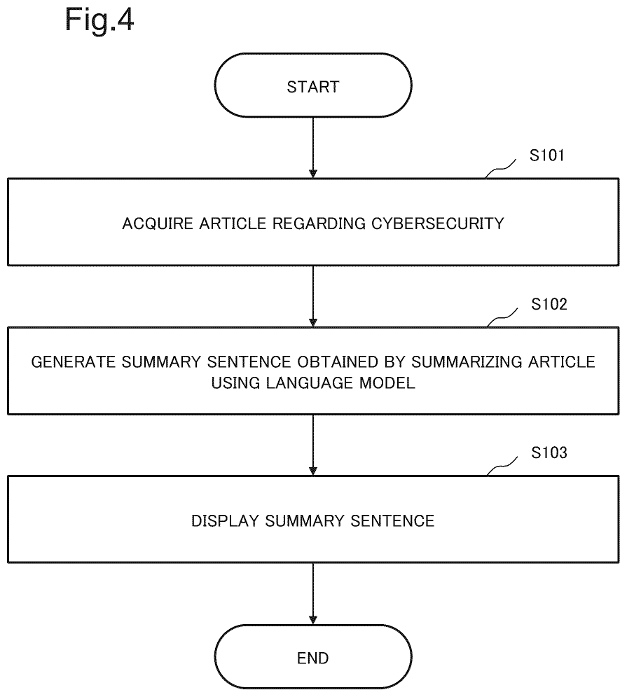

The CPU 501 operates the operating system to control the display device 100 according to the present disclosure. The CPU 501 reads a program and data from a recording medium 506 mounted on, for example, a drive device 507 to a memory. The CPU 501 functions as the acquisition unit 101, the summarizing unit 102, the output unit 103, and a part thereof in the first example embodiment, and executes processing or a command in the flowchart illustrated in FIG. 4 to be described later based on a program.

The recording medium 506 is, for example, an optical disk, a flexible disk, a magnetic optical disk, an external hard disk, a semiconductor memory, or the like. A part of the recording medium of the storage device is a non-volatile storage device, and records a program in the part. The program may be downloaded from an external computer (not illustrated) connected to a communication network.

An input device 509 is achieved by, for example, a mouse, a keyboard, a built-in key button, and the like, and is used for an input operation. The input device 509 is not limited to a mouse, a keyboard, and a built-in key button, and may be, for example, a touch panel. An output device 510 is achieved by, for example, a display, and is used to confirm displaying.

As described above, the display device 100 in the present disclosure is implemented by the computer hardware illustrated in FIG. 2. However, the means for implementing each unit included in the display device 100 of FIG. 1 is not limited to the configuration described above. The display device 100 may be implemented by one physically coupled device, or may be implemented by a plurality of devices by connecting two or more physically separated devices in a wired or wireless manner. The display device 100 may further include a display device such as a display, or may be configured as a system implemented by a device separate from the display device 100.

The acquisition unit 101 is a means that acquires an article regarding cybersecurity. The article regarding cybersecurity is, for example, an article regarding the cyberattack or an article describing countermeasures for preventing the cyberattack. For example, the acquisition unit 101 acquires text data of a new article of a site on the Internet registered in a rich site summary (RSS) every predetermined period. The acquisition unit 101 may acquire articles for each genre of cybersecurity such as cyberattack and vulnerability.

The acquisition unit 101 may also acquire information regarding the degree of attention of each article on the Internet. The degree of attention is, for example, a value calculated based on the number of search results of the web page including the title of the article obtained from the cache of the search engine. When acquiring the text data of the article regarding cybersecurity, the acquisition unit 101 outputs the text data to the summarizing unit 102.

The summarizing unit 102 is a means that generates a summary sentence obtained by summarizing an article using a language model. An example of the language model is software that performs natural language processing according to a model learned using a large amount of text data such as large language models. The type of the language model is not particularly limited as long as the text data can be summarized, and a published language model may be used as it is, or a language model whose source code is published may be improved and used. The summarizing unit 102 may transmit the text data of the article to a device different from the display device 100 and generate the summary sentence using the large language model in another device, or may generate the summary sentence using the large language model stored in the storage device 505.

The summarizing unit 102 may further add a line feed or set a line space to improve readability of the summary sentence summarized using the language model. For example, the summarizing unit 102 may generate a summary sentence in which a line feed is performed at a position of a punctuation mark for each predetermined number of characters. The summarizing unit 102 outputs the generated summary sentence to the output unit 103.

The output unit 103 is a means that displays the summary sentence on the output device 510 or the like. The output unit 103 may generate a screen for displaying the summary sentence and cause a device different from the display device 100 to display the generated screen.

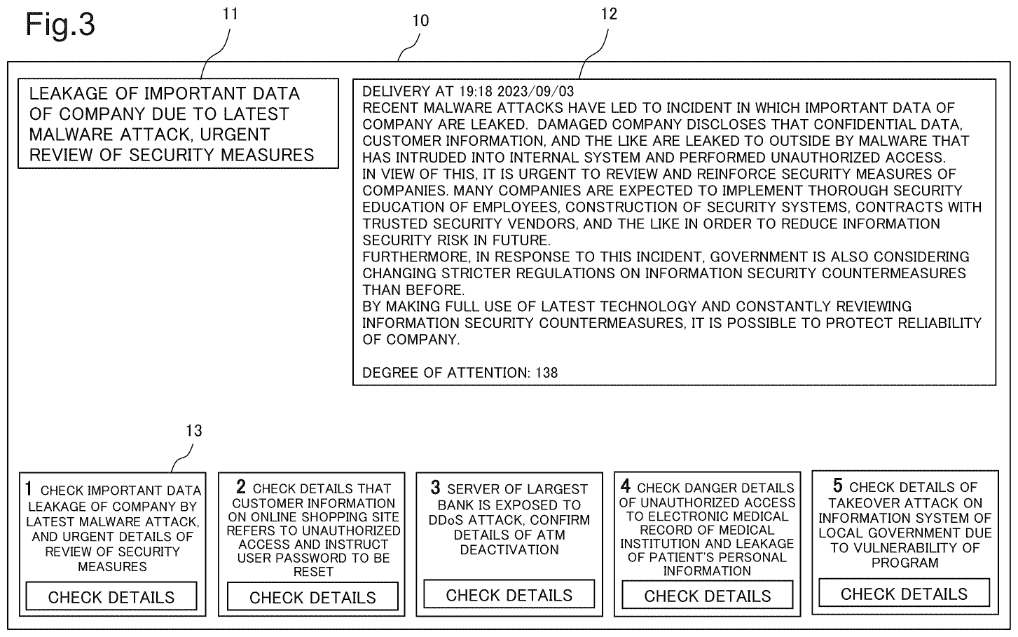

FIG. 3 is an example of a display screen for displaying a summary sentence of an article in the present disclosure. In FIG. 3, a display screen 10 includes a title region 11 displaying the title of the article, a summary region 12 displaying the summary sentence of the article, and a ranking region 13 displaying the title of the article in order of the degree of attention. As illustrated in FIG. 3, the output unit 103 displays the title of the currently displayed article in the title region 11, and displays text data of the summary sentence generated by the summarizing unit 102 in the summary region 12. The output unit 103 displays the value of the degree of attention of the article in the summary region 12. In the example of FIG. 3, 138 is displayed as the degree of attention. The output unit 103 displays the titles of the articles side by side in the ranking region 13 in the order of degree of attention of the articles. In FIG. 3, in a case where a predetermined portion of the ranking region 13 is clicked and selected, the output unit 103 may display the summary sentence of a relevant article. In the example of FIG. 3, in a case where the portion of “confirm details” is clicked, the output unit 103 displays a summary sentence of the relevant article.

The operation of the display device 100 configured as described above will be described with reference to the flowchart of FIG. 4.

FIG. 4 is a flowchart illustrating an outline of the operation of the display device 100 in the present disclosure. The processing according to this flowchart may be executed based on program control by the processor described above. The output unit 103 executes processing according to this flowchart every time the acquisition unit 101 acquires a newly arrived article.

As illustrated in FIG. 4, first, the acquisition unit 101 acquires an article regarding cybersecurity (step S101). Next, the summarizing unit 102 generates a summary sentence obtained by summarizing the article using the language model (step S102). Finally, the output unit 103 displays the summary sentence (step S103). Thus, the display device 100 ends the operation.

In the display device 100 according to the present disclosure, the summarizing unit 102 generates a summary sentence obtained by summarizing an article regarding cybersecurity using a language model. Then, the output unit 103 displays the summary sentence. In this case, since it is not necessary to read the entire article regarding cybersecurity, it is possible to easily grasp the content of the article regarding cybersecurity.

### Second Example Embodiment

Next, a second example embodiment will be described in detail with reference to the drawings. Hereinafter, description of contents overlapping with the above description will be omitted to the extent that the description of the present example embodiment is not unclear. Similarly to the computer device illustrated in FIG. 2, each component in each example embodiment of the present disclosure can be achieved not only by hardware but also by a computer device or software based on program control.

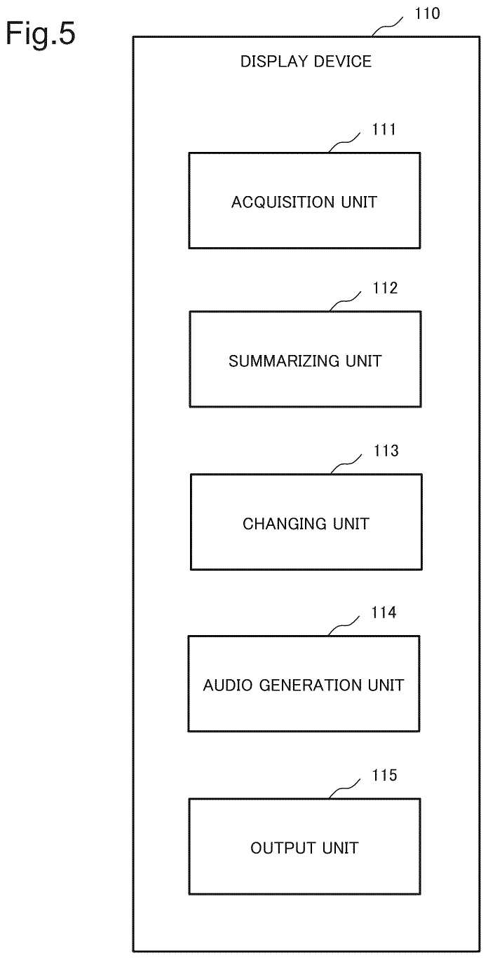

FIG. 5 is a functional block diagram illustrating an example of a configuration of the display device in the present disclosure. With reference to FIG. 5, a display device 110 will be described focusing on a portion different from the display device 100.

The display device 110 includes an acquisition unit 111, a summarizing unit 112, a changing unit 113, an audio generation unit 114, and an output unit 115. The configuration and function of the acquisition unit 111 and the summarizing unit 112 in the display device 110 are similar to those of the acquisition unit 101 and the summarizing unit 102 in the display device 100, and thus, description thereof is omitted here. The display device 110 outputs audio data obtained by reading out the summary sentence generated by the summarizing unit 112.

The changing unit 113 is a means that changes the summarized summary sentence to a reading sentence format. The changing unit 113 changes, for example, the sentence format described in the phrases “da” and “dearu” in Japanese to the reading sentence format of the phrases “desu” and “masu” in Japanese. The changing unit 113 outputs the summary sentence thus changed to the audio generation unit 114.

The audio generation unit 114 is a means that generates audio data obtained by reading out the summary sentence. The audio generation unit 114 may generate audio data read out with a predetermined type of voice, or may generate audio data read out with a type of voice selected by the user. As the type of voice, there is a voice in which at least one of a voice quality, a reading speed, and a voice tone is made different. The audio generation unit 114 may generate audio data obtained by reading out with the voice quality of a specific person. The audio generation unit 114 outputs the generated audio data to the output unit 115.

The output unit 115 is a means that outputs audio data. The audio data generated by the audio generation unit 114 is output from a speaker or the like.

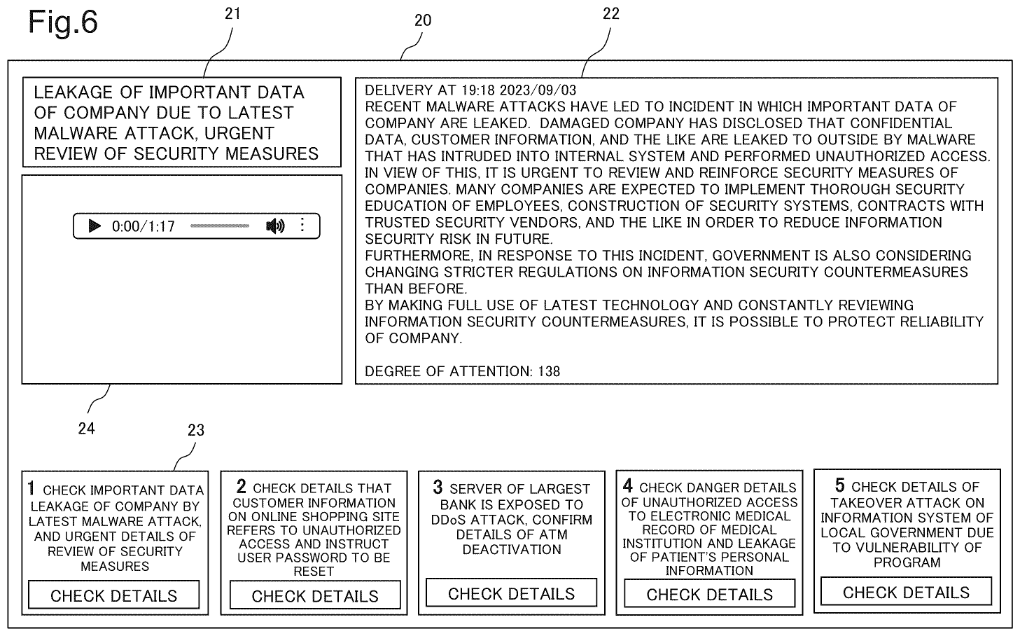

FIG. 6 is an example of a display screen for outputting a summary sentence of an article in the present disclosure. In FIG. 6, the display screen 20 includes an operation region 24 for outputting audio data in addition to a title region 21 for displaying the title of an article, a summary region 22 for displaying the summary sentence of the article, and a ranking region 23 for displaying the title of the article in order of the degree of attention. As illustrated in FIG. 6, a button for reproducing or stopping audio data and a reproduction bar indicating a reproduction position are displayed in the operation region 24.

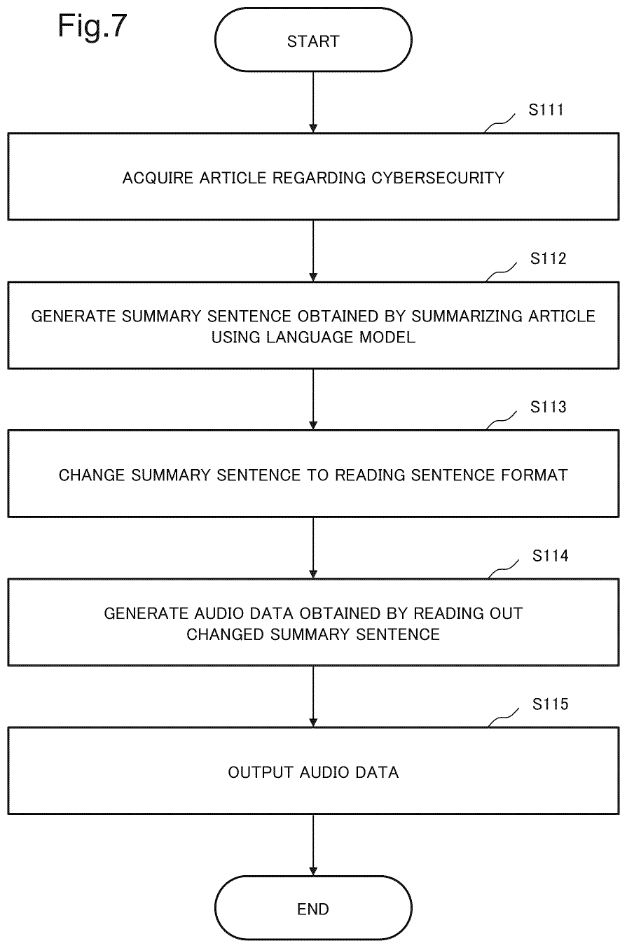

The operation of the display device 110 configured as described above will be described with reference to the flowchart of FIG. 7.

FIG. 7 is a flowchart illustrating an outline of the operation of the display device 110 in the present disclosure. The processing according to this flowchart may be executed based on program control by the processor described above.

As illustrated in FIG. 7, first, the acquisition unit 111 acquires an article regarding cybersecurity (step S111). Next, the summarizing unit 112 generates a summary sentence obtained by summarizing the article using the language model (step S112). Next, the changing unit 113 changes the summary sentence to a reading sentence format (step S113). Next, the audio generation unit 114 generates audio data obtained by reading out the changed summary sentence (step S114). Finally, the output unit 115 outputs the audio data (step S115). Thus, the display device 110 ends the operation.

In the display device 110 according to the present disclosure, the changing unit 113 changes the summary sentence into the reading sentence format, and the audio generation unit 114 generates audio data obtained by reading out the changed summary sentence. Then, the output unit 115 outputs the audio data. In this case, by listening to the audio data of the summary of the article regarding cybersecurity, it is possible to easily grasp the content of the article regarding cybersecurity.

### Third Example Embodiment

Next, a third example embodiment will be described in detail with reference to the drawings. Hereinafter, description of contents overlapping with the above description will be omitted to the extent that the description of the present example embodiment is not unclear. Similarly to the computer device illustrated in FIG. 2, each component in each example embodiment of the present disclosure can be achieved not only by hardware but also by a computer device or software based on program control.

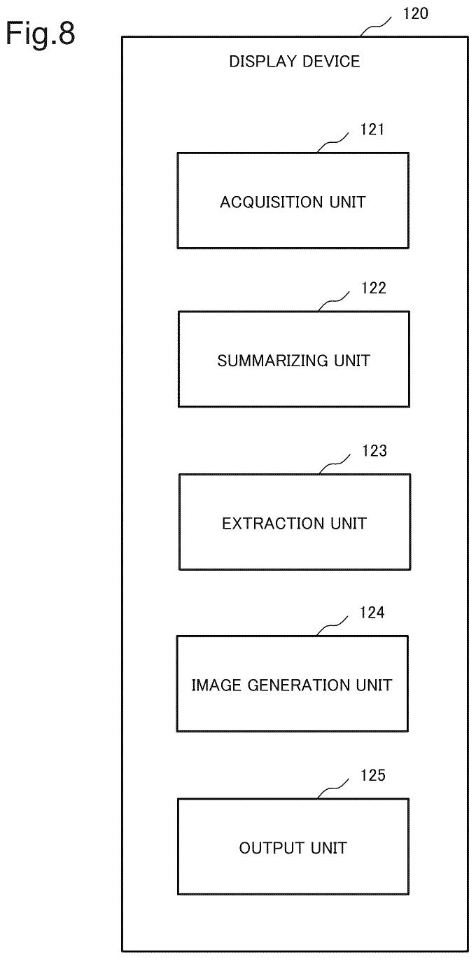

FIG. 8 is a functional block diagram illustrating an example of a configuration of the display device in the present disclosure. With reference to FIG. 8, a display device 120 will be described focusing on a portion different from the display device 100.

The display device 120 includes an acquisition unit 121, a summarizing unit 122, an extraction unit 123, an image generation unit 124, and an output unit 125. The configuration and function of the acquisition unit 121 and the summarizing unit 122 in the display device 110 are similar to those of the acquisition unit 101 and the summarizing unit 102 in the display device 100, and thus, description thereof is omitted here. The display device 120 generates and displays an image matching the content of the summary sentence generated by the summarizing unit 122.

The extraction unit 123 is a means that extracts a keyword related to the cybersecurity from the summary sentence. The extraction unit 123 may extract a keyword using an extraction model learned to appropriately extract a keyword related to the cybersecurity. The extraction unit 123 may extract keywords having an appearance frequency of a predetermined number of times or more in articles regarding cybersecurity in the past.

The image generation unit 124 is a means that generates an image matching the content of the summary sentence using an image generation model based on the extracted keyword. The image generation model used by the image generation unit 124 is not particularly limited as long as an image can be output by inputting a keyword, and may be generated using a published application program. In a case where there is a plurality of extracted keywords, the image generation unit 124 may generate a plurality of images based on each keyword.

The output unit 125 is a means that displays the generated image on the same screen as the summary sentence. In a case where a plurality of images is generated, the output unit 125 may display a plurality of images or may display one image selected according to a predetermined standard.

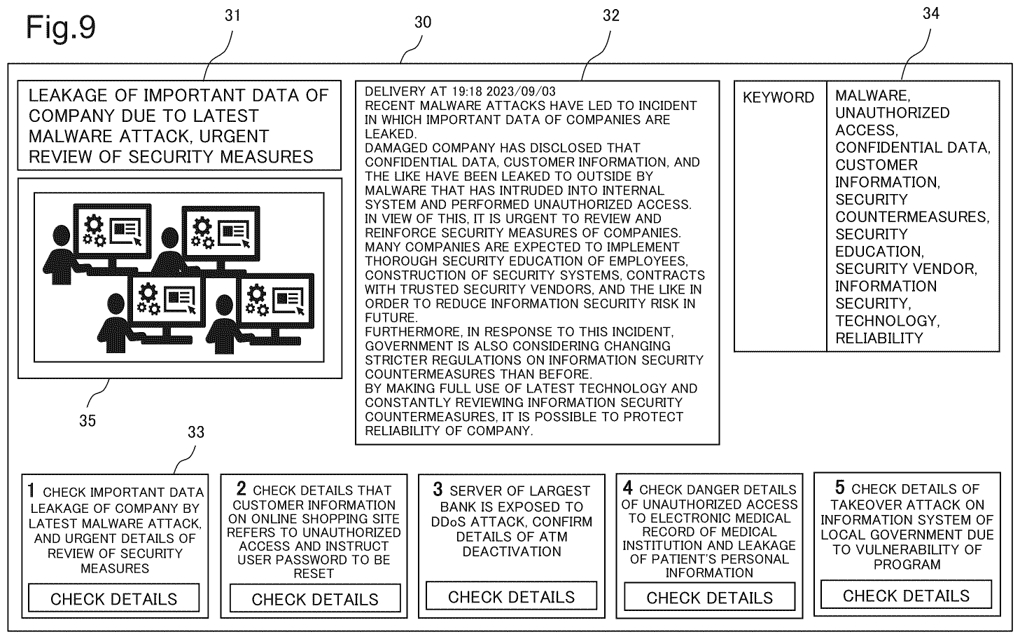

FIG. 9 is an example of a display screen for outputting a summary sentence of an article in the present disclosure. In FIG. 9, a display screen 30 includes a keyword display region 34 for displaying the keyword extracted from the summary article and an image region 35 for displaying the generated image, in addition to a title region 31 for displaying the title of an article, a summary region 32 for displaying the summary sentence of the article, and a ranking region 33 for displaying the title of the article in order of the degree of attention. As illustrated in FIG. 9, in the keyword display region 34, the keyword related to the cybersecurity extracted from the summary sentence displayed in the summary region 32 is extracted. In the image region 35, an image generated using the image generation model based on the extracted keyword is displayed.

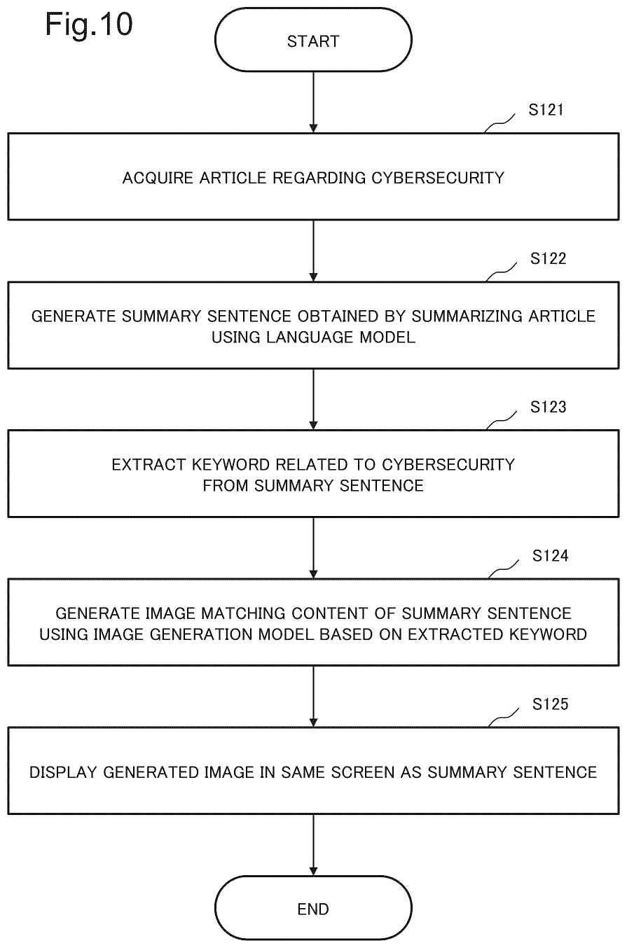

The operation of the display device 120 configured as described above will be described with reference to the flowchart of FIG. 10.

FIG. 10 is a flowchart illustrating an outline of the operation of the display device 120 in the present disclosure. The processing according to this flowchart may be executed based on program control by the processor described above.

As illustrated in FIG. 10, first, the acquisition unit 121 acquires an article regarding cybersecurity (step S121). Next, the summarizing unit 122 generates a summary sentence obtained by summarizing the article using the language model (step S122). Next, the extraction unit 123 extracts a keyword related to the cybersecurity from the summary sentence (step S123). Next, the image generation unit 124 generates an image matching the content of the summary sentence using the image generation model based on the extracted keyword (step S124). Finally, the output unit 125 displays the generated image on the same screen as the summary sentence (step S125). Thus, the display device 120 ends the operation.

In the display device 120 of the present disclosure, the extraction unit 123 extracts a keyword related to the cybersecurity from the summary sentence, and the image generation unit 124 generates an image matching the content of the summary sentence using the image generation model based on the extracted keyword. Then, the output unit 125 displays the generated image on the same screen as the summary sentence. In this case, by reading the summary while viewing the image matching the content of the summary sentence, it is possible to easily grasp the content of the article regarding cybersecurity.

Although the example embodiments of the present disclosure have been described above, the example embodiments can be combined. The combination of the example embodiments makes it easier to grasp the content of the article. For example, in a case where the first example embodiment, the second example embodiment, and the third example embodiment are combined, the display device displays a summary sentence of an article regarding cybersecurity and an image in the summary sentence, and outputs audio data obtained by reading out the summary sentence. Such a display device includes all the components of each example embodiment.

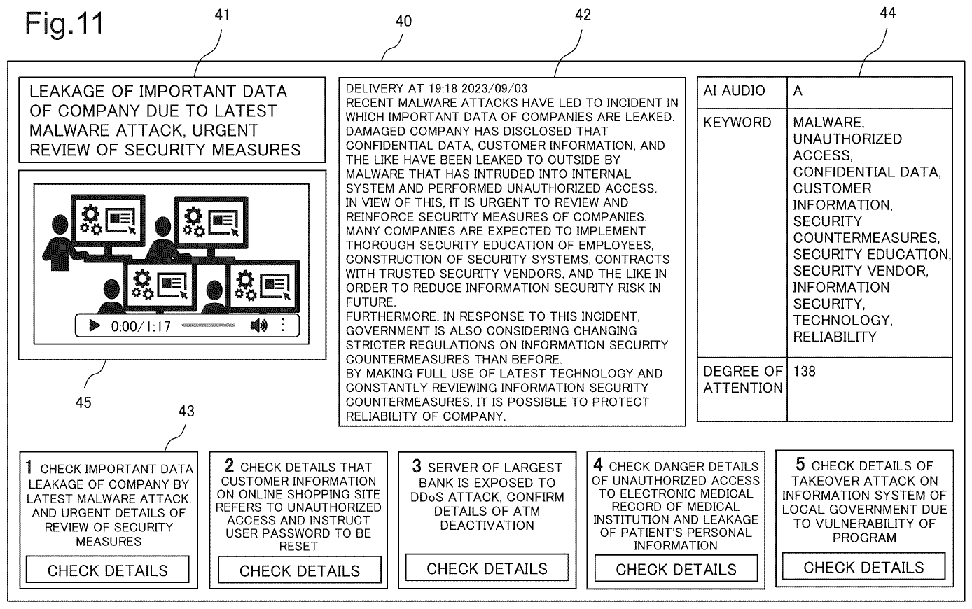

A display screen output by an output unit in this case in which the first example embodiment, the second example embodiment, and the third example embodiment are combined will be described with reference to the drawings. FIG. 11 is a display example of a display screen by the output unit in the present disclosure. As illustrated in FIG. 11, a display screen 40 includes a title region 41 displaying the title of the article, a summary region 42 displaying the summary sentence of the article, a ranking region 43 displaying the title of the article in order of the degree of attention, a keyword display region 44 displaying the keyword extracted from the summary article, and an image region 45 displaying the generated image. In the keyword display region 44, information on the type of voice reading out the audio data and the value of the degree of attention are also displayed. The image region 45 includes an operation button for outputting audio data. In the case of the display screen 40 of FIG. 11, in order to grasp the content of the article, the summary sentence is displayed, audio data obtained by reading out the summary sentence can be output, and an image matching the content of the summary sentence is also displayed. Therefore, the content of the article can be more easily understood.

Even if there is an article regarding cyberattack, it may take time to read the article or it may be difficult to understand the contents.

An example of an effect of the present disclosure is to provide a display device or the like that easily grasps content of an article regarding cybersecurity.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

For example, although the plurality of operations are described in order in the form of a flowchart, the order of description does not limit the order of executing the plurality of operations. Therefore, when each example embodiment is implemented, the order of the plurality of operations can be changed within a range that does not interfere with the content.

Further, it is noted that the inventor's intent is to retain all equivalents of the claimed disclosure even if the claims are amended during prosecution.

Some or all of the above example embodiments may be described as the following Supplementary Notes, but are not limited to the following.

### (Supplementary Note 1)

A display device including:
an acquisition means for acquiring an article regarding cybersecurity;
a summarizing means for generating a summary sentence obtained by summarizing the article using a language model; and
an output means for displaying the summary sentence.

### (Supplementary Note 2)

A display device including:
an acquisition means for acquiring an article regarding cybersecurity;
a summarizing means for generating a summary sentence obtained by summarizing the article using a language model;
a changing means for changing the summarized summary sentence to a reading sentence format;
an audio generation means for generating audio data obtained by reading out a summary sentence; and
an output means for outputting the audio data.

### (Supplementary Note 3)

A display device including:
an acquisition means for acquiring an article regarding cybersecurity;
a summarizing means for generating a summary sentence obtained by summarizing the article using a language model;
an extraction means for extracting a keyword regarding cybersecurity from the summary sentence;
an image generation means for generating an image matching a content of the summary sentence using an image generation model based on the extracted keyword; and
an output means for displaying the generated image on a same screen as the summary sentence.

### (Supplementary Note 4)

The display device according to any one of Supplementary Notes 1 to 3, in which
the acquisition means further acquires information regarding a degree of attention of each article on an Internet, and
the output means displays titles of articles in a display order determined based on the degree of attention.

### (Supplementary Note 5)

The display device according to Supplementary Note 4, in which the output means displays the summary sentence that is relevant in a case where a display region of the title is selected.

### (Supplementary Note 6)

The display device according to any one of supplementary Notes 1 to 3, in which the summarizing means generates a summary sentence in which a line feed is performed at a position of a punctuation mark for each predetermined number of characters.

### (Supplementary Note 7)

The display device according to Supplementary Note 2, in which the audio generation means accepts selection of a type of voice for reading out the summary sentence, and outputs audio data obtained by reading out in accordance with an accepted voice type.

### (Supplementary Note 8)

The display device according to Supplementary Note 3, in which the extraction means extracts a keyword having an appearance frequency of a predetermined number of times or more in an article regarding cybersecurity in a past from the summary sentence.

### (Supplementary Note 9)

A display method causing a computer to execute:
acquiring an article regarding cybersecurity;
generating a summary sentence obtained by summarizing the article using a language model; and
displaying the summary sentence.

### (Supplementary Note 10)

A display method causing a computer to execute:
acquiring an article regarding cybersecurity;
generating a summary sentence obtained by summarizing the article using a language model;
changing the summarized summary sentence to a reading sentence format;
generating audio data obtained by reading out a summary sentence; and
outputting the audio data.

### (Supplementary Note 11)

A display method including:
acquiring an article regarding cybersecurity;
generating a summary sentence obtained by summarizing the article using a language model;
extracting a keyword related to cybersecurity from the summary sentence;
generating an image matching a content of the summary sentence using an image generation model based on the extracted keyword; and
displaying the generated image on a same screen as the summary sentence.

### (Supplementary Note 12)

The display method according to any one of Supplementary Notes 9 to 11, in which
in the acquiring step, information regarding a degree of attention of each article on an Internet is further acquired, and
in the outputting step, titles of articles are displayed in a display order determined based on the degree of attention.

### (Supplementary Note 13)

The display method according to Supplementary Note 12, in which in the outputting step, in a case where a display region of the title is selected, the relevant summary sentence is displayed.

### (Supplementary Note 14)

The display method according to any one of Supplementary Notes 9 to 11, in which in the summarizing step, a summary sentence in which a line feed is performed at a position of a punctuation mark for each predetermined number of characters is generated.

### (Supplementary Note 15)

The display method according to Supplementary Note 10, in which in the audio generating step, selection of a type of voice for reading out the summary sentence is accepted, and audio data read out according to an accepted type of voice is output.

### (Supplementary Note 16)

The display method according to Supplementary Note 11, in which in the extracting step, a keyword having an appearance frequency equal to or higher than a predetermined number of times in an article regarding cybersecurity in a past is extracted from the summary sentence.

### (Supplementary Note 17)

A program that executes:
acquiring an article regarding cybersecurity;
generating a summary sentence obtained by summarizing the article using a language model; and
displaying the summary sentence.

### (Supplementary Note 18)

A program that executes:
acquiring an article regarding cybersecurity;
generating a summary sentence obtained by summarizing the article using a language model;
changing the summarized summary sentence to a reading sentence format;
generating audio data obtained by reading out a summary sentence; and
outputting the audio data.

### (Supplementary Note 19)

A program that executes:
acquiring an article regarding cybersecurity;
generating a summary sentence obtained by summarizing the article using a language model;
extracting a keyword related to cybersecurity from the summary sentence;
generating an image matching a content of the summary sentence using an image generation model based on the extracted keyword; and
displaying the generated image on a same screen as the summary sentence.

### (Supplementary Note 20)

The program according to any one of Supplementary Notes 17 to 19, in which
in the acquiring step, information regarding a degree of attention of each article on an Internet is further acquired, and
in the outputting step, titles of articles are displayed in a display order determined based on the degree of attention.

### (Supplementary Note 21)

The program according to Supplementary Note 20, in which in the outputting step, in a case where a display region of the title is selected, the relevant summary sentence is displayed.

### (Supplementary Note 22)

The program according to any one of Supplementary Notes 17 to 19, in which in the summarizing step, a summary sentence in which a line feed is performed at a position of a punctuation mark for each predetermined number of characters is generated.

### (Supplementary Note 23)

The program according to Supplementary Note 18, in which in the audio generating step, selection of a type of voice for reading out the summary sentence is accepted, and audio data read out according to an accepted type of voice is output.

### (Supplementary Note 24)

The program according to Supplementary Note 19, in which in the extracting step, a keyword having an appearance frequency equal to or higher than a predetermined number of times in an article regarding cybersecurity in a past is extracted from the summary sentence.

1. A display device comprising:
at least one memory configured to store instructions; and
at least one processor configured to execute the instructions to:
acquire an article regarding cybersecurity;
generate a summary sentence obtained by summarizing the article using a language model; and
display the summary sentence.

2. The display device according to claim 1, wherein the at least one processor is further configured to execute the instructions to:
change the summarized summary sentence to a reading sentence format;
generate audio data obtained by reading out a summary sentence; and
output the audio data.

3. The display device according to claim 1, wherein the at least one processor is further configured to execute the instructions to:
extract a keyword related to cybersecurity from the summary sentence;
generate an image matching a content of the summary sentence using an image generation model based on the extracted keyword; and
display the generated image on a same screen as the summary sentence.

4. The display device according to claim 1, wherein the at least one processor is further configured to execute the instructions to:
acquire information regarding a degree of attention of each of the article on an Internet; and
display titles of the articles in a display order determined based on the degree of attention.

5. The display device according to claim 2, wherein the at least one processor is further configured to execute the instructions to:
acquire information regarding a degree of attention of each of the article on an Internet; and
display titles of the articles in a display order determined based on the degree of attention.

6. The display device according to claim 3, wherein the at least one processor is further configured to execute the instructions to:
acquire information regarding a degree of attention of each of the article on an Internet; and
display titles of the articles in a display order determined based on the degree of attention.

7. The display device according to claim 4, wherein the at least one processor is further configured to execute the instructions to, in a case where a display region for one of the titles is selected, display the relevant summary sentence.

8. The display device according to claim 5, wherein the at least one processor is further configured to execute the instructions to, in a case where a display region for one of the titles is selected, display the relevant summary sentence.

9. The display device according to claim 6, wherein the at least one processor is further configured to execute the instructions to, in a case where a display region for one of the titles is selected, display the relevant summary sentence.

10. The display device according to claim 1, wherein the at least one processor is further configured to execute the instructions to generate a summary sentence in which a line feed is performed at a position of a punctuation mark for each predetermined number of characters.

11. The display device according to claim 2, wherein the at least one processor is further configured to execute the instructions to generate a summary sentence in which a line feed is performed at a position of a punctuation mark for each predetermined number of characters.

12. The display device according to claim 3, wherein the at least one processor is further configured to execute the instructions to generate a summary sentence in which a line feed is performed at a position of a punctuation mark for each predetermined number of characters.

13. The display device according to claim 2, wherein the at least one processor is further configured to execute the instructions to:
accept selection of a type of voice for reading out the summary sentence; and
output audio data obtained by reading out in accordance with an accepted voice type.

14. The display device according to claim 3, wherein the at least one processor is further configured to execute the instructions to extract a keyword having an appearance frequency of a predetermined number of times or more in an article regarding cybersecurity in a past from the summary sentence.

15. A display method comprising:
acquiring an article regarding cybersecurity;
generating a summary sentence obtained by summarizing the article using a language model; and
displaying the summary sentence.

16. The display method according to claim 15, further comprising:
changing the summarized summary sentence to a reading sentence format;
generating audio data obtained by reading out a summary sentence; and
outputting the audio data.

17. The display method according to claim 15, further comprising:
extracting a keyword related to cybersecurity from the summary sentence;
generating an image matching a content of the summary sentence using an image generation model based on the extracted keyword; and
displaying the generated image on a same screen as the summary sentence.

18. A non-transitory computer-readable recording medium that records a program for causing a computer to execute:
acquiring an article regarding cybersecurity;
generating a summary sentence obtained by summarizing the article using a language model; and
displaying the summary sentence.

19. The recording medium, according to claim 18, that records the program for causing the computer to further execute:
changing the summarized summary sentence to a reading sentence format;
generating audio data obtained by reading out a summary sentence; and
outputting the audio data.

20. The recording medium, according to claim 18, that records the program for causing the computer to further execute:
extracting a keyword related to cybersecurity from the summary sentence;
generating an image matching a content of the summary sentence using an image generation model based on the extracted keyword; and
displaying the generated image on a same screen as the summary sentence.
